(19) United States
(12) Patent Application Publication
(10) Pub. No.: US 2024/0334465 A1
(43) Pub. Date: Oct. 3, 2024

(54) METHOD AND SYSTEM FOR IMPROVING NETWORK PERFORMANCE TO REDUCE INTERFERENCE

(71) Applicant: Lockheed Martin Corporation, Bethesda, MD (US)

(72) Inventors: Ali Dolatshahi Pirooz, Fremont, CA (US); Gustave Anderson, Roanoke, VA (US); Angela Kuo Wang, Cupertino, CA (US); Julee Pandya, Fremont, CA (US)

(21) Appl. No.: 18/622,454

(22) Filed: Mar. 29, 2024

Related U.S. Application Data
(60) Provisional application No. 63/493,483, filed on Mar. 31, 2023.

(51) Int. Cl. H04W 72/541; H04L 5/00; H04W 72/0453; H04W 74/0808

(52) U.S. Cl. CPC H04W 72/541; H04L 5/0012; H04W 72/0453; H04W 74/0808

(57) ABSTRACT

Embodiments disclose a computer-implemented method. The method includes detecting a stream of network packets for a computing device by a network controller. Based on the stream of network packets, the method includes detecting available frequency channels of a plurality of network stations by the network controller. The network controller may determine and select a plurality of available frequency channels of the plurality of network stations to transmit the stream of network packets. Then, the method performs one or more of: duplicating data of the stream of network packets over the plurality of available frequency channels, beam re-assignment over one or more network stations of the plurality of network stations and beam duplication over the plurality of network stations.

### BENEFIT CLAIM

This application claims the benefit under 35 U.S.C. § 119 (e) of provisional patent application 63/493,483, filed Mar. 31, 2023, the entire contents of which are hereby incorporated by reference as if fully set forth herein.

### TECHNICAL FIELD

This disclosure generally relates to radio frequency (RF) environments and, more particularly, to methods and systems for improving network performance in congested and contested RF environments.

### BACKGROUND

Conventional approaches utilize RF communications, for example, 5G communications, for commercial applications. However, the traditional approaches may have some weaknesses when using such 5G communications for mobile applications, for example, military applications. One of the weaknesses is when a jammer or other relevant source of interference interrupts the communications. In some instances, if the jammer hits a primary and a secondary synchronization signal or physical uplink control channel (PUCCH), a receiver may not be able to detect the RF or data packet. If the jammer affects the physical downlink shared channel (PDSCH) or physical uplink shared channel (PUSCH), the signal may not be detected at the receiver, and the receiver may not be able to demodulate the signal. For example, in military applications, these affected signal communication issues may not be acceptable.

### BRIEF DESCRIPTION OF THE DRAWINGS

FIG. 1 illustrates an example overview of a distributed network environment, according to an embodiment.

FIG. 2 is an example flowchart illustrating a method for improving network performance, according to an embodiment.

FIG. 3 illustrates an example architecture of a network station and computing device (user equipment) for data duplication, according to an embodiment.

FIG. 4 illustrates an example of frequency bands, according to an embodiment.

FIG. 5 illustrates an example of baseband structure for aggregating network packets, according to an embodiment.

FIG. 6 illustrates an example of multiple basebands using multiplexes, combiners, and RF antennas according to an embodiment.

FIG. 7 illustrates an example of dual connectivity techniques and data duplication techniques, according to an embodiment.

FIG. 8A and FIG. 8B illustrates an example of frequency diversity techniques according to an embodiment.

FIG. 9 illustrates an example of data duplication to avoid jammers and interference, according to an embodiment.

FIG. 10A, FIG. 10B, FIG. 10C and FIG. 10D illustrates an example interface displaying network signals, according to an embodiment.

FIG. 11A, FIG. 11B, FIG. 11C and FIG. 11D illustrates an example interface displaying network signals affected by jammer and interference, according to an embodiment.

FIG. 12 illustrates an example computer system according to certain embodiments.

### DETAILED DESCRIPTION

### Overview

Embodiments of the present disclosure relate to a computer-implemented method. The method may be performed by a system including a network controller and a computing device. The method includes detecting a stream of network packets for a computing device by a network controller. The method then detects available frequency channels of a plurality of network stations by the network controller based on the stream of network packets. The method includes selecting a plurality of available frequency channels of the plurality of network stations by the network controller to transmit the stream of network packets. The method includes performing, by the network controller based on a network capability of the computing device, one or more of: duplicating data of the stream of network packets over the plurality of available frequency channels, beam re-assignment over one or more network stations of the plurality of network stations and beam duplication over the plurality of network stations.

Embodiments of the present disclosure relate to a system, including a network controller and a computing device. The network controller may be configured to detect a stream of network packets for the computing device. The network controller may be configured to detect available frequency channels of a plurality of network stations based on the stream of network packets. The network controller may be configured to select a plurality of available frequency channels of the plurality of network stations to transmit the stream of network packets. The network controller may be configured to perform, based on a network capability of the computing device, one or more of: duplicating data of the stream of network packets over the plurality of available frequency channels, beam re-assignment over one or more network stations of the plurality of network stations and beam duplication over the plurality of network stations.

Embodiments of the present disclosure relate to a non-transitory computer-readable medium storing instructions that, when executed by a processor, causes the processor to perform one or more steps. The processor may be configured to detect a stream of network packets for a computing device. The processor may be configured to detect available frequency channels of a plurality of network stations by the network controller based on the stream of network packets. The processor may be configured to select a plurality of available frequency channels of the plurality of network stations to transmit the stream of network packets by the network controller. The processor may be configured to perform, by the network controller based on a network capability of the computing device, one or more of: duplicating data of the stream of network packets over the plurality of available frequency channels, beam re-assignment over one or more network stations of the plurality of network stations and beam duplication over the plurality of network stations.

Other technical advantages will be readily apparent to one skilled in the art from the following figures, descriptions, and claims. Moreover, while specific advantages have been enumerated above, various embodiments may include all, some, or none of the enumerated advantages.

### Example Embodiments

In cellular communications, data duplication and agility provide added resilience to network communication systems (for example, 5G) and facilitate overcoming a jammer or other source of interference interrupting communication. These approaches leverage techniques that use spatial, temporal, and spectral diversity to mitigate or evade interference.

In an embodiment, data duplication and agility may be implemented within a centralized unit (CU) (radio resource control (RRC) and packet data convergence protocol (PDCP)). In an embodiment, data duplication and agility may include path selection and circuit management that allows for delivery to an end user equipment device (UE) over a variety of paths leveraging Integrated Access and Backhaul (IAB-Mesh), UE-to-UE side links and additional base stations for both uplink and downlink communications. This manner of leveraging packet duplication or diverse path selection allows for the evasion of interference. For example, the path selection change may be triggered from the channel quality indicator (CQI) and hybrid automatic repeat requests (HARQ) in the downlink jammer effect. In an embodiment, data duplication may be applied via the PDCP duplication mechanism across a variety of carriers, Resource Blocks (RBs), and/or physical beams. In an embodiment, agility may include information that allows a signal to continuously hop to other carrier frequencies using OFDM symbols-based presence of interference or intelligent defined patterns. The RRC may make decisions about the pattern and periodicity of hopping.

In an embodiment, data duplication and agility may be implemented within a distributed unit (DU) (radio link control (RLC), media access control (MAC) and high-phy). For example, when a narrowband jammer shows up on some RBs of a symbol in a carrier, the network switches to other RBs of the same symbol. This process and command happen at layer 2. The carrier change may be triggered from the CQI and HARQ in the downlink jammer effect. This carrier change may occur within the scheduler in the MAC. In an embodiment, data duplication may be implemented at the MAC Layer, using the carrier aggregation mechanisms that carry data across multiple OFDM symbols (or multiple carriers). This manner of leveraging the MAC scheduler to implement intelligent time-hopping mechanisms makes it challenging for an interferer to know when (in time) and where (in frequency) transmissions may occur to interfere with that transmission effectively.

In an embodiment, data duplication and agility may be implemented at the physical layer (PHY). For example, packets may move to a new carrier frequency via RRC at determined or intelligent intervals and may move the attached users to a new RU through some predetermined or intelligent pattern. In an embodiment, duplicate information may be transmitted on multiple beams (same or multiple carriers), making it very challenging for a jammer to overcome the geometry effectively. Both control and user channels may be sent via the base stations to the UE from multiple directions. This process and command happen at layers 2 and/or 3 of the network.

Embodiments of the present disclosure provide a method, a system, and a non-transitory storage medium for determining and detecting frequency channels or carriers of nearby or any remote network stations to transmit or carry the network packets/data packets to transmit to a computing device. Based on the available frequency channels or carriers, the method performs anti-jam techniques, for example, frequency diversity and spatial diversity. In an embodiment, the frequency diversity may include (a) frequency hopping, including intra and inter-frequency hopping; (b) frequency re-assignment, including intra and inter-frequency re-assignment; and (c) data duplication on multiple carriers that may include contiguous and/or noncontiguous. In an embodiment, spatial diversity includes (a) beam re-assignment from more than one base station and (b) beam duplication from more than one base station. In an embodiment, the anti-jam techniques, for example, data duplication, frequency hopping, beam re-assignment, beam duplication, and frequency re-assignment may be performed in a centralized unit (CU) of the network stations, distributed unit (DU) of the network stations, or a radio unit (RU) of a physical layer of the network stations. In an embodiment, the decision to implement the anti-jam techniques may be determined by a network controller of a network station/network node/base station.

In some embodiments, the present disclosure performs frequency diversity and spatial diversity by using carrier aggregation. Embodiments may include duplicating physical network/interface (PHY) processing that involves one duplicating process for each component carrier at the media access control (MAC) layer of the base station/network node while keeping the radio-link control (RLC) layer and higher layers identical to the non-aggregation case. In some embodiments, various types of network packet aggregations over multiple carriers may include, for example, intra-band contiguous, intra-band non-contiguous, and inter-band non-contiguous.

In some embodiments, the present disclosure determines frequency patterns and periodicity of frequency hops, and the patterns and periodicity of hops depend upon the kind or type of interference. Based on the patterns and periodicity of hops, the network packets from the base station hop over different frequency channels or carriers. The hops may be synchronous or asynchronous and contiguous or non-contiguous, which may depend upon the type and network bandwidth/capacity of the computing device.

In some embodiments, dual connectivity (DC) and data duplication (DD) techniques may be provided to duplicate data over various frequency channels/carriers. The dual connectivity uses radio resources from one or more multiple carriers over multiple base stations/network node bases (gNBs) to improve user throughput or reliability. In an embodiment, data duplication may include a subset of dual connectivity features to improve reliability. The data duplication may include detecting the available frequency channels/carriers of the network stations, selecting two or more channels/carriers, and performing data duplication at the packet data convergence protocol (PDCP) level (PDCP duplication). In an embodiment, data duplication may include splitting data between master gNB (MgNB) and secondary gNB (SgNB). In particular, in a downlink direction, network packets may arrive at the MgNB and automatically be duplicated at the PDCP level. The duplicated packets may be sent to the SgNB over an X2 network interface of the base station. In some embodiments, data may be duplicated on one or more multiple carriers of the available frequency channels of the network stations, resource blocks (RBs) of the network stations, and beams of the network stations.

In an embodiment, the computing device may select one of the duplicated data packets based on the network type and network bandwidth/capacity of the computing device. In particular, the receiver or the computing device may detect the interference and select a packet from the channels not affected by the jammer or interference. In an embodiment, the receiver may coherently combine the arrived packets that are not affected by the strong jammers or interference. The computing device may receive the network packets from different frequency channels based on one or more of a highest signal-to-noise ratio (SNR) and a least error vector magnitude (EVM) of the network packets and combine the network packets in a frequency band from the different frequency channels based on the network capability of the computing device.

Embodiments of the present disclosure provide improved network communication capability to avoid jamming or interference for applications in contested or congested RF environments. In some embodiments, the present disclosure relates to a modified network connection and communication for use in various mobile, network, and RF environmental applications. For example, the present disclosure may provide modified 5G use in military applications. The present disclosure may be applied to any cellular and non-cellular communication networks, including but not limited to any Internet of Workers (IoW), internet of things (IoT) and 5G. Embodiments relate to a modified network approach to overcome a jammer or other sources of interference and interrupting communication. For example, the network approach may be 5G and the network signals may be 5G signals. In an embodiment, smart frequency hopping of the network signal may be provided along with a copy of the network signal in one or more frequency channels. For example, the copy of the network signal may be generated in two frequency channels within one orthogonal frequency-division multiplexing (OFDM) symbol or outside of the OFDM symbol. In an embodiment, several copies of the same network signal may be generated and sent in parallel via several frequency channels. In different frequency channels, the network signal and the signal copies may hop every K OFDM symbol in time. In an embodiment, K may be as low as “1”, depending upon the operation of the network signal. In some embodiments, the network communication may allow the hopping in certain scenarios for every one slot (14 OFDM symbol). In an embodiment, smart and systematic hopping may make the communication system more reliable when dealing with jammers or other sources of interference. For example, transferring the signal and signal copies in several frequency channels in parallel also may increase the system reliability when dealing with narrow-band or wideband jammers.

Embodiments of the present disclosure provide benefits of using a modified network approach for various network applications, for example, military applications. Using the modified approach overcomes a jammer or other relevant source of interference from interrupting communication. In an embodiment, frequency hopping increases the possibility of avoiding the jammer in 5G wireless communication system. Prior approaches utilize network communication that lacks smart and systematic frequency hopping within one symbol or several symbols. In an embodiment, in dual connectivity, two or more different packets may be sent in two or more frequency channels in parallel to increase throughput. In an embodiment, two or more of the same packets may be sent to avoid the jammer or source interference affecting some channels. Within the embodiments disclosed herein, the possibility of a jamming signal becomes very low and may not be an interruption in the communication. The receiver may select the effective and best packet from the channels not affected by the jammer or interference. In an embodiment, the receiver may coherently combine the arrived packets that are not affected by the strong jammers or interference.

The embodiments disclosed herein are only examples, and the scope of this disclosure is not limited to them. Particular embodiments may include all, some, or none of the components, elements, features, functions, operations, or steps of the embodiments disclosed herein. Embodiments according to the present disclosure are in particular disclosed in the attached claims directed to a method, a storage medium, a system, and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well so that any combination of claims and the features thereof are disclosed and can be claimed regardless of the dependencies chosen in the attached claims. The subject matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

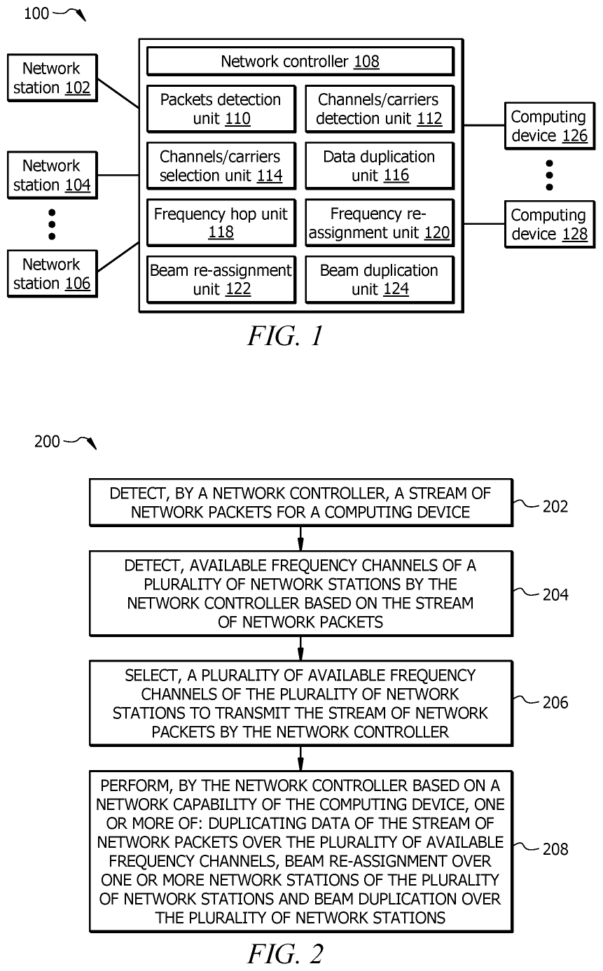

FIG. 1 illustrates the distributed network environment 100 with which one embodiment can be implemented and comprises components/elements that are implemented at least partially by hardware at one or more network stations, and one or more computing devices, such as one or more controlling units, network processing units, one or more hardware processors executing stored program instructions stored in one or more memory units for performing the functions that are described herein. In other words, all functions described herein are intended to indicate operations that are performed using programming in a special-purpose computer or general-purpose computer in various embodiments. FIG. 1 illustrates only one of many possible arrangements of components configured to execute the programming described herein. Other arrangements may include fewer or different components, and the division of work between the components may vary depending on the arrangement.

In an embodiment, the distributed network environment 100 may be a multi-tenant environment. The distributed network environment 100 may include various network stations 102, 104, 106, and computing devices 126, 128. The distributed network environment 100 may include ‘n’ number of network stations, sub-network stations, segments of network stations, zones, sub-zones of network stations, antenna, sub-part of antennas and other network interface and elements. The environment 100 may include ‘n’ number of computing devices. The designation n in reference characters means that in embodiments, the actual number of stations, interfaces, networks, sub-parts, zones, and elements corresponding to a reference character has no specific limit other than the processing capability of related elements.

In an embodiment, network stations 102, 104, 106 may include base stations, mobile cellular stations, non-cellular stations, access networks, remote stations, access points, network antennas, tactical network stations, remote terminal stations, wireless stations, wired stations, wireless local loop (WLL) stations, RF based network stations, tactical systems, tactical networks, tactical radios, WiFi nodes, radio systems, blue force tracking of personnel and equipment (NB-IoT), massive machine type communications (mMTC) networks, wireless modems, routers, network processing stations, baseband stations, carrier stations, channels stations, modulating stations, internet of things (IoT), enhanced mobile broadband (eMBB), securing connection to edge computing and real-time sensing nodes and a combination thereof. The network stations 102, 104, 106 may include all functions, units, and components that can provide frequency carriers, bands, channels, links, paths, and other mediums to carry, communicate and distribute/transmit network packets, data packets, stream of packets, partitioned packets, RF signal packets, RF packets, tactical packets, cellular packets, non-cellular packets, audio streams, video streams, images, AR-based streams, and other networking packets to the computing devices 126, 128. In an embodiment, the network stations 102, 104, 106 including other network stations may include centralized unit (CU), distributed unit (DU) and radio unit (RU) for performing data duplication, frequency hopping, frequency re-assignment, beam duplication, and beam re-assignment.

In an embodiment, the network stations 102, 104, 106 may be communicatively connected to the computing devices 126, 128 over one or more data communication networks (not shown) to enable network packets exchange and communications between devices, stations, and components of the distributed network environment 100. Examples of the data communication network include, without limitation, an ad hoc network, an intranet, an extranet, a virtual private network (VPN), a local area network (LAN), a wireless local area network (WLAN), a wide area network (WAN), a wireless wide area network (WWAN), a metropolitan area network (MAN), a portion of the Internet, a portion of the Public Switched Telephone Network (PSTN), near-field communication (NFC) network, a cellular technology-based network, a satellite communications technology-based network, Bluetooth, a cellular telephone network, or a combination of two or more of these networks. In an embodiment, the one or more data communication networks may include any suitable links. For example, the links may include but are not limited to, one or more wireline (for example, Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET), satellite links or Synchronous Digital Hierarchy (SDH)) links. Links need not necessarily be the same throughout the environment 100. One or more links may differ in one or more aspects from one or more other links. The network stations 102, 104, 106 and the computing devices 126, 128 and other components of the distributed network environment 100 may host or include interfaces that are compatible with one or more networks and are programmed or configured to use standardized protocols for communication across the networks such as application programming interface (API) calls, transmission control protocol (TCP)/internet protocol (IP), Bluetooth, and higher-layer protocols such as hypertext transfer protocol (HTTP), transport layer security (TLS), and the like. One or more interfaces may be utilized to enable communication over the frequency channels/carriers and the interfaces may include switches, access points, routers, wireless fidelity (WIFI) interface, a LAN interface, a WAN interface, or a modem. As a further example, the network interface may include a WIFI interface, a modem, a switch, or a router. In an embodiment, the network interface may be configured to use any suitable type of communication protocol as would be appreciated by one of ordinary skill in the art.

In an embodiment, one or more network controllers 108 may be configured in any of the network stations 102, 104, 106. As one example, the network controller 108 may be installed at network station 102. The network controller 108 may comprise a set of executable program instructions or units of instructions such as executables, binaries, packages, functions, methods, or objects. In an embodiment, the network controller 108 may be hard-wired to perform the techniques or may include functions of digital electronic devices such as at least one ASIC or field programmable gate array (FPGA) that is persistently programmed to perform the techniques or may include at least one general purpose hardware processor programmed to perform the techniques pursuant to program instructions in firmware, memory, other storage, or a combination. Such devices may also combine custom hard-wired logic, ASICs, or FPGAs with custom programming to accomplish the described techniques. The network controller 108 may include processor(s), memory, interfaces and system modules. The processor(s) of the network controller 108 may be any electronic circuitry including, but not limited to, state machines, one or more CPU chips, logic units, cores (e.g., a multi-core processor), FPGAs, ASICs, or digital signal processors (DSPs). The processor may be a programmable logic device, a microcontroller, a microprocessor, or any suitable combination of the preceding. The processor is communicatively coupled to and in signal communication with the memory and the interface. The processor may be configured to process data and may be implemented in hardware and/or software. For example, the processor may be 8-bit, 16-bit, 32-bit, 64-bit or of any other suitable architecture. The processor may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

The memory of the network controller 108 includes one or more disks, tape drives, or solid-state drives, and may be used as an over-flow data storage device to store programs when such programs are selected for execution and to store instructions and data that are read during program execution. The memory may be volatile or non-volatile and may include ROM, random access memory (RAM), ternary content addressable memory (TCAM), dynamic random-access memory (DRAM), and static random-access memory (SRAM).

Network controller 108 may include various processing and controlling units that include but are not limited to, packets detection unit 110, channels/carriers detection unit 112, channels/carriers selection unit 114, data duplication unit 116, frequency hop unit 118, frequency re-assignment unit 120, beam re-assignment unit 122 and beam duplication unit 124.

Packets detection unit 110 may be programmed or configured to detect a stream of network packets at a network station 102/104/106 for a computing device 126/128.

Channels/carriers detection unit 112 may be programmed or configured to detect frequency channels that are available at or by a plurality of network stations 102, 104, 106. In an embodiment, the frequency channels may be available at the network station where the network controller 108 may be operating, for example, network station 102 and/or the other network stations 104 and 106. In an embodiment, channels/carriers detection unit 112 may be programmed to identify a plurality of other frequency channels of the other network stations coupled to the network stations 102, 104, 106.

Channels/carriers selection unit 114 may be programmed to select a plurality of available frequency channels of the plurality of network stations 102, 104, 106 to transmit the stream of network packets. In an embodiment, channels/carriers selection unit 114 may be programmed to detect interference affecting the available frequency channels and select the plurality of available frequency channels unaffected by the interference. In an embodiment, channels/carriers detection unit 114 may be programmed to identify and select a plurality of other frequency channels of the other network stations coupled to the network stations 102, 104, 106. Channel/carriers selection unit 114 may be configured to perform the duplication of network packets over various frequency bands of the selected available frequency channels/carriers. In an embodiment, channel/carriers selection unit 114 may be programmed to partition network packets into sub-packets, sub-streams, and sub-data over various frequency bands of the available frequency channels/carriers.

Data duplication unit 116 may be programmed to duplicate data of the stream of network packets over the plurality of available frequency channels to avoid the jammer and interruptions. In an embodiment, data duplication unit 116 may be programmed to duplicate data on one or more multiple carriers of the available frequency channels of the network stations 102, 104, 106, resource blocks (RBs) of the network station 102, 104, 106 and beams of the network stations 102, 104, 106.

Frequency hop unit 118 may be programmed to perform frequency hopping, based on frequency patterns and periodicity of hopping over selected frequency channels that are not affected by interference.

Frequency re-assignment unit 120 may be programmed to perform reassigning frequency (frequency reassigning function) among the selected and available frequency channels to avoid interference.

Beam re-assignment unit 122 and beam duplication unit 124 may be programmed to beam re-assignment and beam duplication of network packets over the beams of network stations 102, 104, and 106, including other network stations of the environment.

In an embodiment, the computing devices 126, 128 may comprise any kind of computing device such as a desktop computer, computer system, computing system, laptop computer, tablet computer, mobile computing device, smartphone, personal computers, personal digital assistants (PDAs), laptops, or workstations, notebook, netbook, tablet computer, e-book reader, GPS device, camera, personal digital assistant (PDA), handheld electronic device, cellular telephone, smartphone, augmented/virtual reality (AR/VR) device, mixed reality (MR) device, other suitable electronic devices, or any suitable combination thereof. In some embodiments, the electronic device 100 may comprise an AR device including, but not limited to, a head-mounted display device (HMD), an electromyographic wearable device (EMG), a head-up display device (HUD), AR glasses (smart glasses), smartphone AR (mobile AR), tethered AR headsets and any other devices with AR features. Throughout this disclosure, all references to “user” or “users” are specified for convenience but correspond to computing device/electronic device that executes the technical steps described in the disclosure. Thus, even where the terms “user” or “users” appear, all steps and functions of the disclosure are intended as computer-implemented steps or technical steps and not manual, mental, human-performed, or abstract steps, each of which is hereby expressly excluded from the scope of the claims and the disclosure. In an embodiment, the computing device 126, 128 may comprise one or more processors to implement computer-executable instructions that are stored in one or more memory or memory units of the computing device 126, 128. In an embodiment, the computing devices 126 and 128 may be configured to select network packets of required quality from different frequency channels, for example, beams, carriers, duplicated channels, and re-assigned channels/carriers based on determining that a particular beam or channel is not affected by the interference. Each of the computing devices 126 and 128 may be configured to receive the network packets from the frequency channels and beams based on the highest signal-to-noise ratio (SNR) and least error vector magnitude (EVM) of the network packets. Each of the computing devices 126 and 128 may be configured to combine network packets in one or more frequency bands based on the network capability of the service of the computing devices 126 and 128.

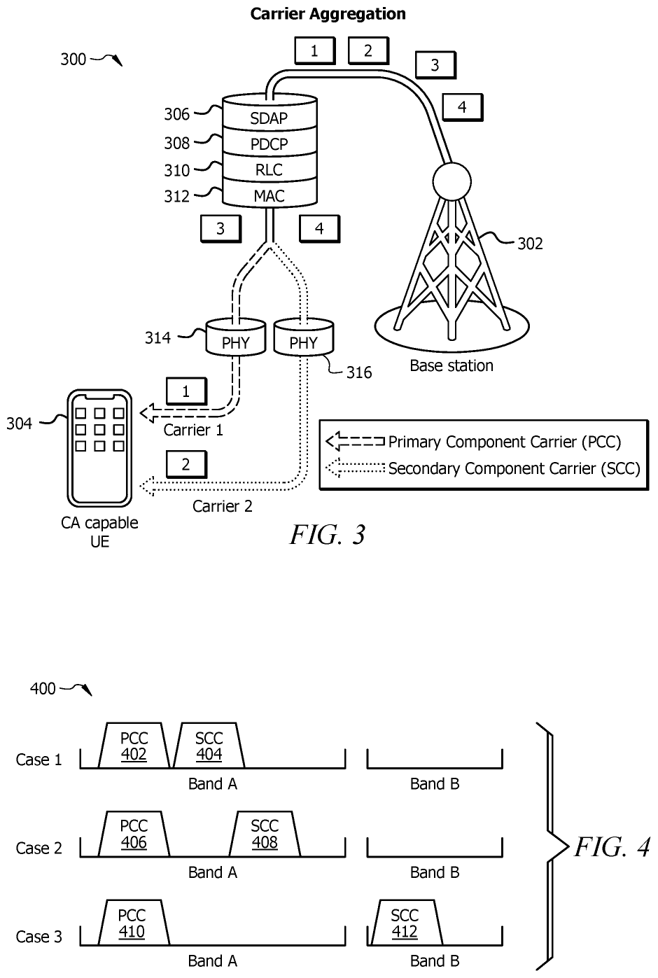

FIG. 2 is an example flowchart illustrating a method or process for improving network performance, according to an embodiment. The process may be implemented by a network controller at a network station that may direct other network stations to improve network performance in congested RF environments. The process implemented by the network controller may send or program any of the network stations 102, 104, 106 to perform anti-jam techniques, for example, frequency diversity and spatial diversity. In an embodiment, the frequency diversity may include (a) frequency hopping, including intra and inter-frequency hopping; (b) frequency re-assignment, including intra and inter-frequency re-assignment; (c) data duplication on multiple carriers that may include contiguous and/or noncontiguous. In an embodiment, spatial diversity includes (a) beam re-assignment from more than one base station and (b) beam duplication from more than one base station. In an embodiment, the anti-jam techniques, for example, data duplication, frequency hopping, beam re-assignment, beam duplication, and frequency re-assignment, may be performed in a CU of the network stations, DU of the network stations, and RU of a physical layer of the network stations.

The process begins at step 202 when a stream of network packets is detected by the network controller 108 of a network station (for example, 102). In an embodiment, one or more network stations 102, 104, 106 may be configured to broadcast network packets for the computing device 126 and/or 128. When sending the stream of network packets, the network controller 108 may be configured to detect the transmission and analyze various ways for network performance optimization by avoiding jammers and other sources of interruption of the transmission or using the network packets. The process may include analyzing the type of network packets, the bandwidth required to send the network packets, the size of the network packets, the priority of network packets and service quality and network capacity of computing device 126/128 for receiving the network packets.

At step 204, the process may be programmed to detect various kinds of frequency channels available at the network station 102 and other network stations 104, 106. The process may include determining the frequency channels that can transmit a load of network packets in a parallel and/or partitioned manner.

At step 206, the process may be programmed to select a plurality of available frequency channels of the plurality of network stations 102, 104, 106 to transmit the stream of network packets by the network controller 108. In an embodiment, the process may select the available frequency channels based on detecting interference affecting the available frequency channels and select the available frequency channels that are not affected by the interference. In an embodiment, the interference corresponds to an interruption in communicating the stream of network packets by one or more jammers and other sources of interference. In some embodiments, the process may be programmed to determine one or more other network stations to identify a plurality of other frequency channels available in each of the one or more other network stations to carry the network packets for the computing device 126/128. The other frequency channels are identified based on detecting the interference and the frequency channels that are not affected by the interference are selected by the network controller 108.

At step 208, the process may be programmed to perform anti-jam techniques, for example, frequency diversity and spatial diversity. In an embodiment, the frequency diversity may include frequency hopping, intra and inter-frequency hopping, frequency re-assignment, intra and inter-frequency re-assignment, and data duplication on multiple carriers that may include contiguous and/or noncontiguous. In particular, based on the network capability of the computing device 126/128, the process may perform one or more duplicating data of the stream of network packets over the plurality of available frequency channels, frequency hopping over the plurality of available frequency channels, and reassigning frequency among the plurality of available frequency channels. In an embodiment, spatial diversity includes beam re-assignment from more than one base station and beam duplication from more than one base station. In an embodiment, the anti-jam techniques, for example, data duplication, frequency hopping, beam re-assignment, beam duplication, and frequency re-assignment, may be performed in a CU of the network stations, DU of the network stations, and RU of the physical layer of the network stations. In an embodiment, the decision to implement the anti-jam techniques may be determined by a network of a network station/network node/base station.

In an embodiment, the process may select the channels that are not affected by the interference and performs the one or more of the duplicating data, the frequency hopping, the reassigning frequency, beam duplication, and beam reassignment. In an embodiment, the process may include determining frequency patterns and periodicity of data hopping based on the detected interference and performing frequency hopping over the plurality of available frequency channels based on the frequency patterns and the periodicity of the data hopping.

In an embodiment, the process may include determining one or more other network stations by the network controller 108 to identify a plurality of other frequency channels available in each of the one or more other network stations. The process performs one or more beam duplication and beam re-assignment at the network stations, including other network stations, based on the plurality of other frequency channels available. The process may include communicating the stream of network packets by the one or more network stations to the computing device 126 based on any of the one or more of the beam duplication and beam re-assignment.

In an embodiment, the computing device 126 may choose to receive the packets from same or different frequency channels that are not affected by the interference and based on one or more of a highest signal-to-noise ratio (SNR) and a least error vector magnitude (EVM) of the network packets. The computing device 126 may be configured to combine the network packets in a frequency band from different or same frequency channels based on the network capability of the computing device 126.

In an embodiment, the frequency diversity technique may be data duplication. For example, data duplication may be performed for 5G networking environments. In the frequency diversity technique, the same network signal or same network packets or the same stream of network packets may be sent on two or more carriers from one transmitter of the network stations 102, 104, 106. The process may be programmed to perform minor modifications in dual connectivity features of the network communication (for example, 5G) to implement frequency diversity. The data duplication involves splitting data packets, stream of network/data packets, or data in two or more cells or frequency channels or carriers over two or more frequencies from one transmitter of the network station 102, 104, 106 to increase the data rate. In an embodiment, dual connectivity and/or data duplication techniques include copying the same data packets or data stream on two or more cells or carriers or channels over two or more base stations with the same frequency. In an embodiment, dual connectivity and/or data duplication technique includes copying the same data packets or data or stream on two or more cells or carriers or channels over two or more base stations with different frequencies. This process of data duplication achieves network communication with more resilience.

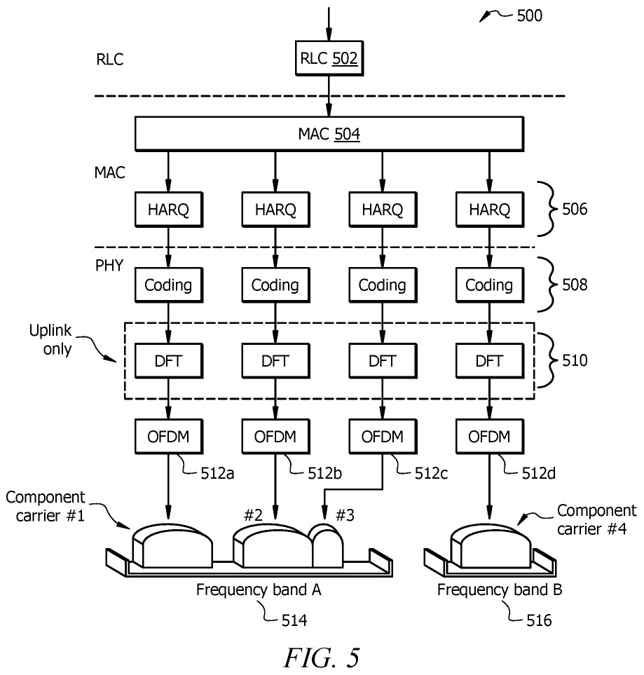

FIG. 3 illustrates an example architecture 300 of a network station and computing device (user equipment) for data duplication, according to an embodiment. For example, FIG. 3 illustrates the base station 302 that may be one of the network stations 102, 104, 106 and any of the network stations 102, 104, 106 may be installed with the network controller 108. The FIG. 3 also shows a user equipment (UE) 304 capable of performing data duplication. In an embodiment, the base station 302 and the UE 304 may include various layers, for example, service data adaptation protocol (SDAP) layer 306, packet data convergence protocol (PDCP) layer 308, radio-link control (RLC) layer 310 and media access control (MAC) layer 312. In an embodiment, SDAP layer 306 may be responsible for quality of service (QOS) flow handling across the 5G air interface and may exist in user plane in both gNB 302 and UE 304. SDAP layer 306 may interface to upper layers via QoS flows and the to the PDCP layer 308 via data radio bearers (DRBs). PDCP layer 308 may be located in radio protocol stack of network air interface on top of the RLC layer 310 and may perform segmentation, reordering, concatenation, error correction, flow control and acknowledgments of network packets. In an embodiment, data duplication may involve duplicating PHY processing at 314 and 316 layers. Data duplication may be performed for each component carrier at the MAC layer 312 while keeping the RLC layer 310 and above identical to the non-duplication case. For example, network packets 1, 2, 3, 4 may carried over various layer 306, 308, 310, 312. The network packets 1 and 3 may segmented and sent over carrier 1 via PHY layer 314 to the UE 304 and the network packets 2 and 4 may be sent over carrier 2 via PHY layer 316 to the UE 304. In an embodiment, carrier 1 may be primary component carrier (PCC) and carrier 2 may be secondary component carrier (SCC). This way of segmentation and data duplication increases bandwidth and data rates, or throughput increases for both uplink and downlink. In an embodiment, data duplication may be performed in various types, for example, intra-band contiguous, intra-band non-contiguous, inter-band non-contiguous, and a combination thereof. Various benefits of data duplication include, but are not limited to, an increase in bandwidth and data rates or throughputs for both uplink and downlink, network operators may choose to deploy network packets or streams in any of the three carrier of particular bandwidth or types, which helps in aggregation of licensed and un-licensed spectrums and improves network efficiency of network packets communication over any kind of network capability (5G or any network). In an embodiment, data duplication may be used for both time division duplex (TDD) and frequency division duplex (FDD) topologies.

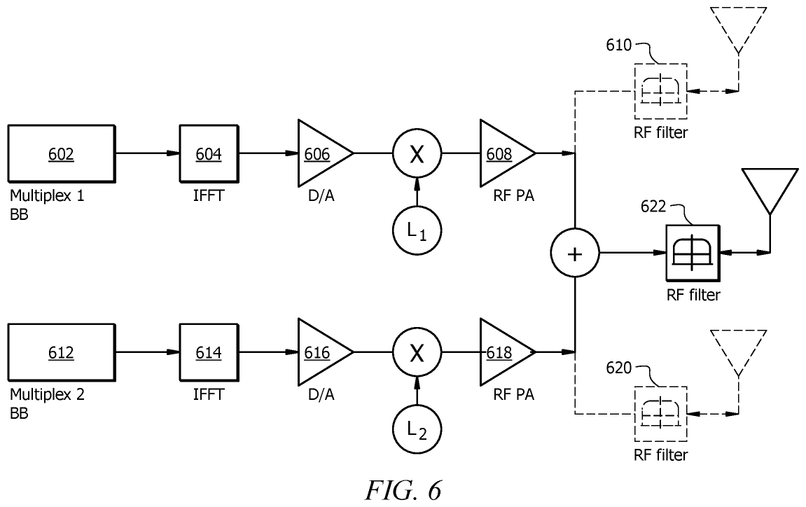

FIG. 4 illustrates an example of frequency bands of different types of data duplication and data partitioning according to an embodiment. A first branch for data may use PCC and a second branch for data may use SCC. In an embodiment, the synchronization and control information may be sent over PCC. The data packets or user data may be split between the PCC and SCC. In an embodiment, SCC may not include any control signal. Referring to FIG. 4, case 1 illustrates intra-band contiguous frequency bands having both PCC 402 and SCC 404 on one frequency band “Band A”. Case 2 illustrates intra-band non-contiguous frequency bands with PCC 406 and SCC 408 on the same band “Band A” but non-contiguous. Case 3 illustrates inter-band non-contiguous frequency bands with PCC 410 on “Band A” and SCC 412 on “Band B”.

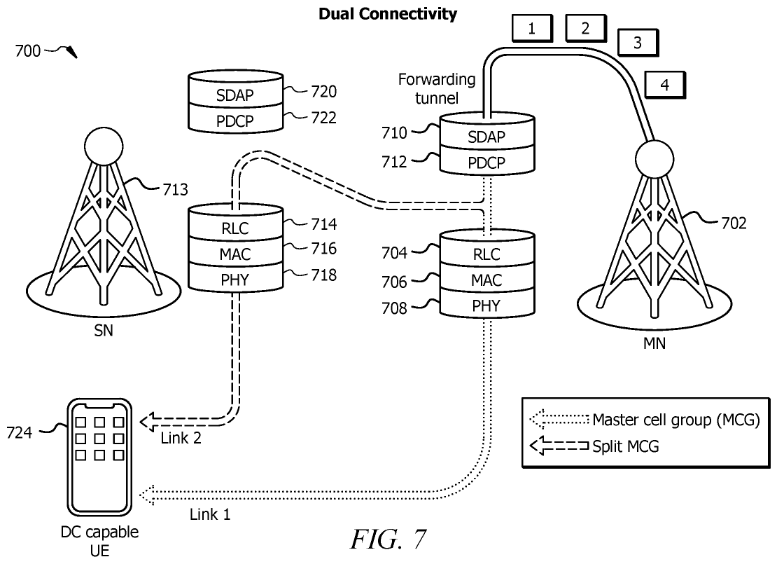

FIG. 5 illustrates an example of baseband structure for aggregating network packets according to an embodiment. The baseband structure may be described with one transmitter of a base station 500 that includes layers of RLC 502, MAC 504, PHY 508, uplink discrete frequency transform (DFT) 510, and orthogonal frequency division multiplexing (OFDM) (512a, 512b, 512c and 512d). The network packets may be aggregated in intra-band contiguous, intra-band non-contiguous, and inter-band non-contiguous. For example, network packets may be sent over various hybrid automatic repeat requests (HARQ) 506, coding 508, uplink layers of DFTs 510, and OFDMs 512. The network packets may be aggregated into frequency band A 514, having component carriers 1, 2, and 3 in one band 514 and component carrier 4 in another band 516.

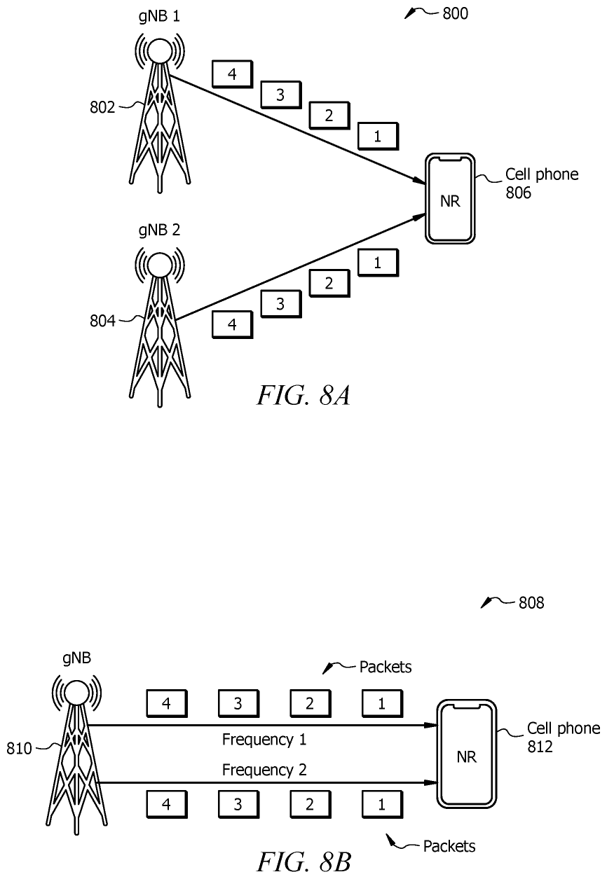

FIG. 6 illustrates an example of multiple basebands using multiplexes, combiners, and RF antennas according to an embodiment. FIG. 6 illustrates multiple basebands 602, 612, inverse fast Fourier transform (IFFT) 604, 614, digital to analog (DAC) 606, 616, RF power amplifier (PA) 608, 618, RF filters 610, 620 and 622, high-power combiner to single antenna OR dual antenna (multiple input multiple output (MIMO)). In an embodiment, MIMO 3GPP TR 36.815 (3^{rd} generation partnership project technical reports) may be utilized for E-ULTRA and includes long term evolution (LTE) advanced feasibility for radio access network (RAN) workgroup 4 (WG4). In an embodiment, data duplication on L1 and RF front end may be illustrated. FIG. 6 shows data duplication with two carriers multiplex baseband 602 and 612. The two carriers may be sent over one antenna if the two frequencies are in the same frequency band. The two carriers may be sent over two antennas if the two frequencies are in two separate frequency bands. For example, 5G new radio carrier aggregation may include aggregation up to 16 CCs, and up to 1 GHz of spectrum. In an embodiment, carriers may use different numerologies and may perform transport block mapping per carrier basis. Carrier aggregation in 5G NR may be used for both frequency 1 (FR1) below 6 GHz and FR2 above 6 GHz in millimeter wave range of frequency bands. In one example, prior approaches of commercial cell phone companies do not include data duplication capabilities on their base stations/UEs due to spectrum limitations. One of the obstacles in the prior approaches may include spectrum limitation for data duplication. Table 1 below shows 5G standard in band 78 with NR carrier aggregation (CA) configuration/Bandwidth combination set.

TABLE 1
NR CA configuration/Bandwidth combination set

| | | Channel | Channel | Channel | Maximum |
|---|---|---|---|---|---|
| | Bandwidth | band- | band- | band- | aggregated |
| NR CA | combi- | widths | widths | widths | band- |
| Config- | nation | for carrier | for carrier | for carrier | widths |
| uration | set | (MHz) | (MHz) | (MHZ) | (MHZ) |
| CA_{—} | 0 | 20 | 50 | | 70 |
| n78B | | | | | |
| CA_{—} | 0 | 50 | 60, 80, 100 | | 200 |
| n78C | | 60 | 60, 80, 100 | | |
| | | 80 | 80, 100 | | |
| | | 100 | 100 | | |
| CA_{—} | 1 | 10 | 100 | | 200 |
| n78C | | 15, 20 | 90, 100 | | |
| (1) | | 25, 30 | 80, 90, 100 | | |
| | | 40 | 70, 80, | | |
| | | 50, 60, 70, | 90, 100 | | |
| | | 80, 90, 100 | 60, 70, 80, | | |
| | | | 90, 100 | | |
| CA_{—} | 0 | 100 | 100 | 100 | 300 |
| n78D | | | | | |

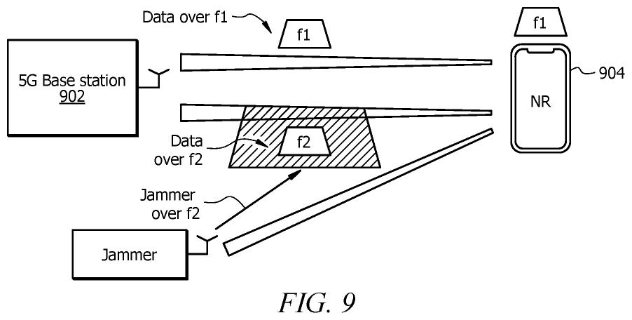

FIG. 7 illustrates an example of dual connectivity techniques and data duplication techniques. In an embodiment, FIG. 7 describes dual connectivity that uses radio resources from one or more multiple carriers over multiple base stations (gNBs) to improve user throughput or reliability. For example, FIG. 7 shows two base stations, with one base station as the master (or primary) node (MN) 702 and the other base station as the secondary node (SN) 713. Both base stations 702 and 713 include layers of RLC (704 and 714), MAC (706 and 716), PHY (708 and 718), SDAP (710 and 720) and PDCP (712 and 722). Data duplication (DD) or duplicating data may be a subset of dual connectivity features to improve reliability. The network packets or user plane may be split in data duplication may be performed at PDCP 712 levels, which may be referred to as PDCP duplication. Data duplication may be utilized by splitting data between master gNB (MgNB) and secondary gNB (SgNB). In an embodiment, in the downlink direction, packets may arrive at the MgNB buffer and may automatically be duplicated at the PDCP level. The duplicated packet may be sent to the SgNB over the X2 network interface. After the packets reach the respective MgNB and SgNB, both base stations (MgNB and SgNB) may perform their functions separately. The scheduling and HARQ functions may be independent of the two gNBs. In the case of a failure in one of the links, the transmission of the packets through the other link can possibly be successfully received at the UE, which improves the reliability. For dual connectivity to work properly, the control signals via MgNB may be processed and linked to the established, and then the advantage of SgNB to be utilized. For example, the network packets or data may be split and sent over PDCP 712. One of the packets may be sent from MN 702 or master cell group (MCG) via link 1 and other duplicated packet may be forwarded to the other base station 713 via forwarding tunnel and to the UE 724 via link 2. In an embodiment, dual connectivity may be defined only for downlink signals.

In an embodiment, duplicating data may be performed on multiple carriers, multiple channels, resource blocks (RBs), and beams of the network stations. data duplication property for jammer avoidance increases network resiliency to jammers. For example, instead of sending two different packets in the two bands to increase the data rate, the same packet may be copied in the second band, and both packets may be transmitted. The receiver may check the packet and its copies in both bands and select the one with the highest SNR and/or least EVM. The receiver may be capable of detecting the packet signals even if one frequency band is affected by the jammer while the second band is unaffected by the interference.

In some embodiments, for duplicating data, network packets or data may be sent on multiple carriers. This involves sending data via multiple carrier frequencies to the computing device 126 or the receiver from one source or base station 102. The data may be split in layer 2 protocol. One or more carriers may have control information while they each have the same user information. In an embodiment, control channels may switch across multiple carriers and/or be copied on each of the carriers. The computing device 102 selects the carriers that are not affected by the jammer. In an embodiment, network packets may switch between carriers if a jammer is present on a carrier frequency. In particular, if the jammer interrupts a carrier frequency, the network switches to another carrier of the multiple carriers. This process and command may be performed on layer 2 of the network protocol. The carrier change may be triggered from the information from channel quality indicator (CQI) and HARQ in the downlink jammer effect. In an embodiment, the network switch to another carrier may be implemented on a predetermined interval that moves the network packets from one frequency channel to a new center frequency via RRC and moves all attached users (phone network) to a new RU through a predetermined frequency pattern. In an embodiment, the carrier switching may be implemented for both frequency hopping and duplicating data.

In some embodiments, duplication or redirection of data may be implemented on multiple base stations. At the presence of the jammer, the protocol at layer 3 switches the route to another base station that is not affected by the jammer for the communication with UE/computing device 126. The gNB change may be triggered from the information from CQI and HARQ in the downlink jammer effect.

In an embodiment, data may be sent on multiple channels. For example, if a narrowband jammer shows up on some RBs of a symbol in a carrier, the network switches to other RBs of the same symbol. This process and command may be implemented at layer 2. The carrier change over different RBs of the same or different symbols may be triggered by the information from CQI and HARQ in the downlink jammer effect. In an embodiment, the DU (distributed unit) of a base station may be configured to select a new channel at a predetermined interval to transmit the packets to another base station or computing device 126.

In an embodiment, frequency hopping may involve information or network packets/data to continuously hop to other carrier frequencies or RBs within an OFDM symbol based on a defined pattern. The decision about the frequency pattern and periodicity of hopping may be taken at layer 2. Frequency hopping intervals may be flexible from some slots to some frames. Both user data and control data may hop in both frequency and time.

In an embodiment, duplicating data may be implemented on multiple beams or gNBs. Duplicated information may be transmitted on multiple beams, which makes it very challenging for a jammer to overcome the geometry effectively. Both control and user channels are sent via the base stations to the UE from multiple directions. This process and command may be implemented at layer 2 and/or layer 3 of the network.

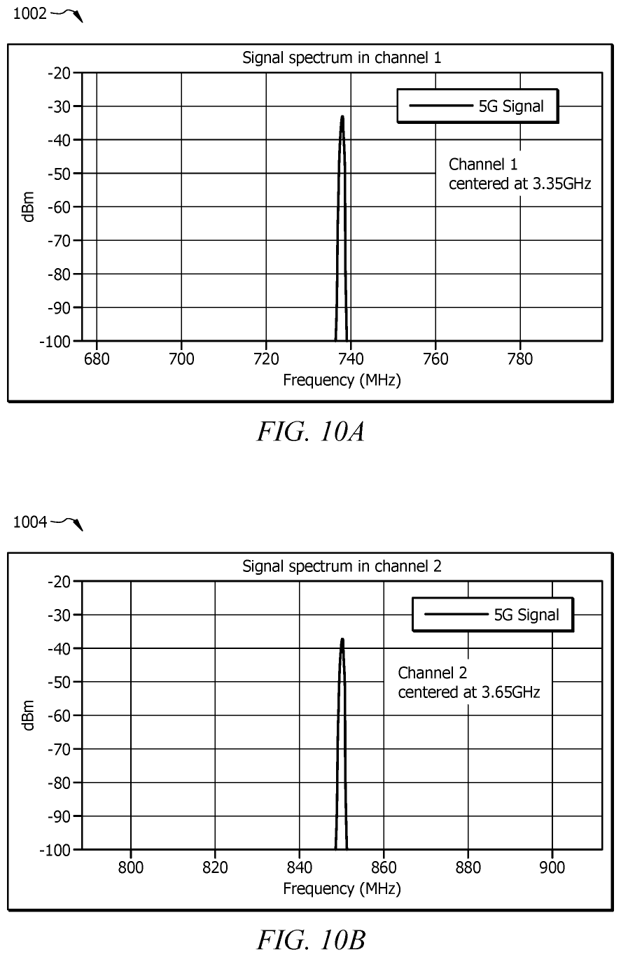

FIG. 8A and FIG. 8B illustrate an example of frequency diversity techniques according to an embodiment. FIG. 8A illustrates beam duplication in which the network packets may be transmitted by both base station 802 (gNB1) and 804 (gNB2) to the computing device 806 and the computing device 806 may choose one of the network packet streams from one of the base stations 802 or 804 based on network capability of the device 806. FIG. 8B illustrates duplicating data by one base station 810 that duplicates data packets in two different frequency channels, for example, one stream of packets in one frequency channel 1 and a copy of a stream of packets in another frequency channel 2. The computing device 812 may choose one of the network packet streams from one of the frequency channels, 1 or 2, based on the network capability of device 806.

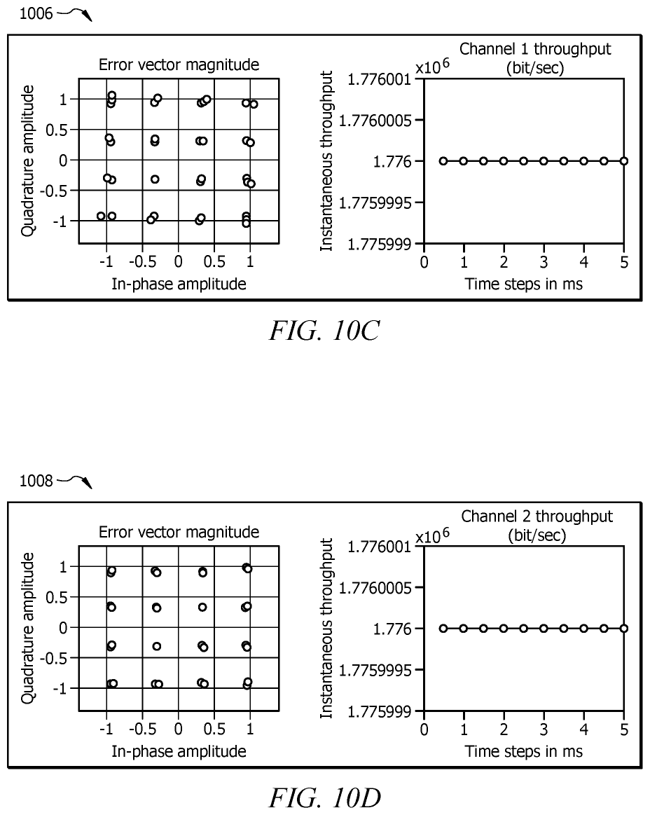

FIG. 9 illustrates an example of data duplication to avoid jammers and interference, according to an embodiment. If a jammer attacks or interferes with the transmission over frequency channel f2, the receiver or the UE 904 may be capable of receiving the data packets from frequency channel f1 sent by the base station 902.

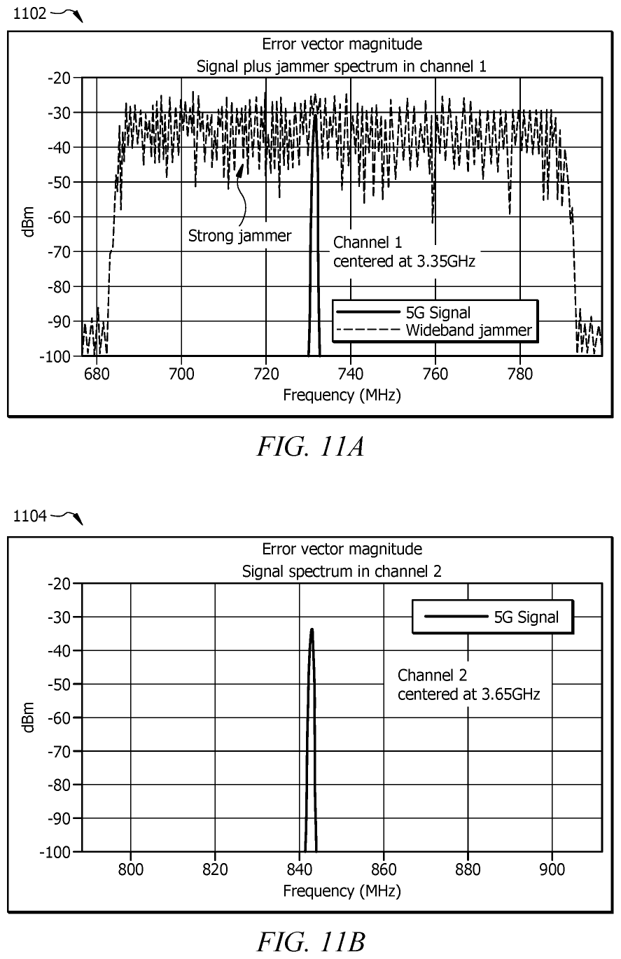

FIG. 10A-FIG. 10D illustrates an example interface displaying network signals, according to an embodiment. The data may be sent to channel 1, denoted by 1002 in FIG. 10A, and channel 2, denoted by 1004 in FIG. 10B. The throughput of channel 1 “1002” with EVM results is shown at 1006 in FIG. 10C and throughput of channel 2 “1004” with EVM results is shown at 1008 in FIG. 10D.

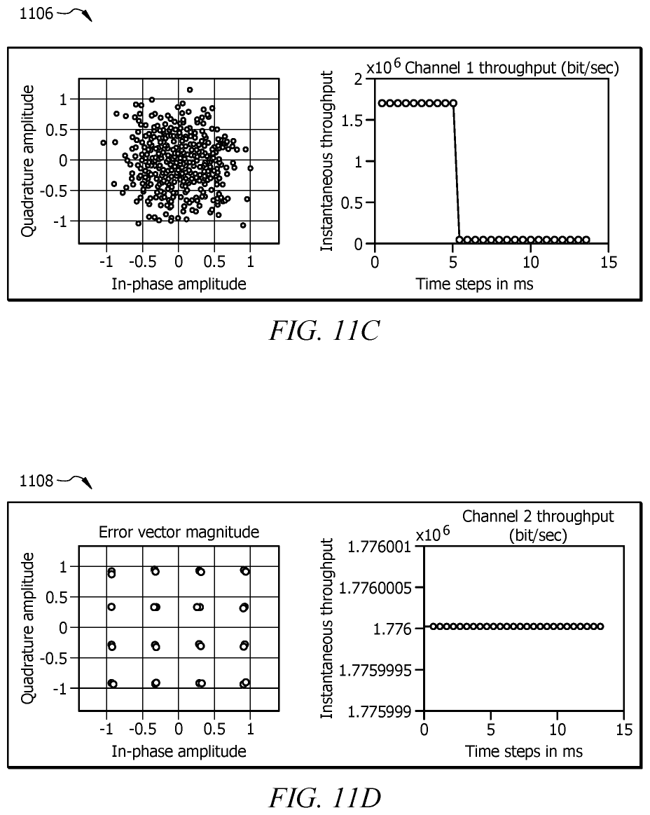

FIG. 11A-FIG. 11D illustrates an example interface displaying network signals affected by jammer and interference, according to an embodiment. For example, if the jammer interferes with channel 1 “1102” in FIG. 11A, the copy of the data at channel 2 “1104” in FIG. 11B may be sent to the computing device. The throughput of channel 1 “1104” affected by the jammer is shown at “1106” as shown in FIG. 11C, and the throughput of channel 2 “1104” unaffected by the jammer is shown at 1108 in FIG. 11D.

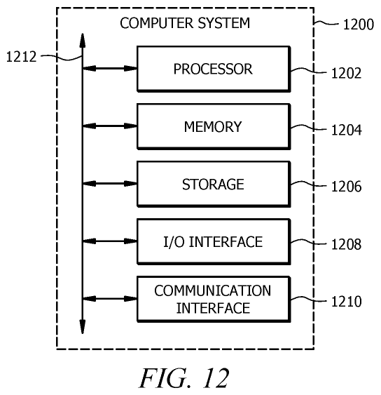

FIG. 12 illustrates an example computer system 1200. In particular embodiments, one or more computer systems 1200 perform one or more steps of one or more methods described or illustrated herein. In particular embodiments, one or more computer systems 1200 provide the functionality described or illustrated herein. In particular embodiments, software running on one or more computer systems 1200 performs one or more steps of one or more methods described or illustrated herein or provides functionality described or illustrated herein. Particular embodiments include one or more portions of one or more computer systems 1200. Herein, reference to a computer system may encompass a computing device, and vice versa, where appropriate. Moreover, reference to a computer system may encompass one or more computer systems, where appropriate.

This disclosure contemplates any suitable number of computer systems 1200. This disclosure contemplates computer system 1200 taking any suitable physical form. As example and not by way of limitation, computer system 1200 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1200 may include one or more computer systems 1200; be unitary or distributed; span multiple locations; span multiple machines; span multiple data centers; or reside in a cloud, which may include one or more cloud components in one or more networks. Where appropriate, one or more computer systems 1200 may perform without substantial spatial or temporal limitation one or more steps of one or more methods described or illustrated herein. As an example and not by way of limitation, one or more computer systems 1200 may perform in real time or in batch mode one or more steps of one or more methods described or illustrated herein. One or more computer systems 1200 may perform at different times or at different locations one or more steps of one or more methods described or illustrated herein, where appropriate.

In particular embodiments, computer system 1200 includes a processor 1202, memory 1204, storage 1206, an input/output (I/O) interface 1208, a communication interface 1210, and a bus 1212. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1202 includes hardware for executing instructions, such as those making up a computer program. As an example and not by way of limitation, to execute instructions, processor 1202 may retrieve (or fetch) the instructions from an internal register, an internal cache, memory 1204, or storage 1206; decode and execute them; and then write one or more results to an internal register, an internal cache, memory 1204, or storage 1206. In particular embodiments, processor 1202 may include one or more internal caches for data, instructions, or addresses. This disclosure contemplates processor 1202 including any suitable number of any suitable internal caches, where appropriate. As an example and not by way of limitation, processor 1202 may include one or more instruction caches, one or more data caches, and one or more translation lookaside buffers (TLBs). Instructions in the instruction caches may be copies of instructions in memory 1204 or storage 1206, and the instruction caches may speed up retrieval of those instructions by processor 1202. Data in the data caches may be copies of data in memory 1204 or storage 1206 for instructions executing at processor 1202 to operate on; the results of previous instructions executed at processor 1202 for access by subsequent instructions executing at processor 1202 or for writing to memory 1204 or storage 1206; or other suitable data. The data caches may speed up read or write operations by processor 1202. The TLBs may speed up virtual-address translation for processor 1202. In particular embodiments, processor 1202 may include one or more internal registers for data, instructions, or addresses. This disclosure contemplates processor 1202 including any suitable number of any suitable internal registers, where appropriate. Where appropriate, processor 1202 may include one or more arithmetic logic units (ALUs); be a multi-core processor; or include one or more processors 1202. Although this disclosure describes and illustrates a particular processor, this disclosure contemplates any suitable processor.

In particular embodiments, memory 1204 includes main memory for storing instructions for processor 1202 to execute or data for processor 1202 to operate on. As an example and not by way of limitation, computer system 1200 may load instructions from storage 1206 or another source (such as, for example, another computer system 1200) to memory 1204. Processor 1202 may then load the instructions from memory 1204 to an internal register or internal cache. To execute the instructions, processor 1202 may retrieve the instructions from the internal register or internal cache and decode them. During or after execution of the instructions, processor 1202 may write one or more results (which may be intermediate or final results) to the internal register or internal cache. Processor 1202 may then write one or more of those results to memory 1204. In particular embodiments, processor 1202 executes only instructions in one or more internal registers or internal caches or in memory 1204 (as opposed to storage 1206 or elsewhere) and operates only on data in one or more internal registers or internal caches or in memory 1204 (as opposed to storage 1206 or elsewhere). One or more memory buses (which may each include an address bus and a data bus) may couple processor 1202 to memory 1204. Bus 1212 may include one or more memory buses, as described below. In particular embodiments, one or more memory management units (MMUs) reside between processor 1202 and memory 1204 and facilitate accesses to memory 1204 requested by processor 1202. In particular embodiments, memory 1204 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1204 may include one or more memories 1204, where appropriate. Although this disclosure describes and illustrates particular memory, this disclosure contemplates any suitable memory.

In particular embodiments, storage 1206 includes mass storage for data or instructions. As an example and not by way of limitation, storage 1206 may include a hard disk drive (HDD), a floppy disk drive, flash memory, an optical disc, a magneto-optical disc, magnetic tape, or a Universal Serial Bus (USB) drive or a combination of two or more of these. Storage 1206 may include removable or non-removable (or fixed) media, where appropriate. Storage 1206 may be internal or external to computer system 1200, where appropriate. In particular embodiments, storage 1206 is non-volatile, solid-state memory. In particular embodiments, storage 1206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1206 taking any suitable physical form. Storage 1206 may include one or more storage control units facilitating communication between processor 1202 and storage 1206, where appropriate. Where appropriate, storage 1206 may include one or more storages 1206. Although this disclosure describes and illustrates particular storage, this disclosure contemplates any suitable storage.

In particular embodiments, I/O interface 1208 includes hardware, software, or both, providing one or more interfaces for communication between computer system 1200 and one or more I/O devices. Computer system 1200 may include one or more of these I/O devices, where appropriate. One or more of these I/O devices may enable communication between a person and computer system 1200. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1208 for them. Where appropriate, I/O interface 1208 may include one or more device or software drivers enabling processor 1202 to drive one or more of these I/O devices. I/O interface 1208 may include one or more I/O interfaces 1208, where appropriate. Although this disclosure describes and illustrates a particular I/O interface, this disclosure contemplates any suitable I/O interface.

In particular embodiments, communication interface 1210 includes hardware, software, or both providing one or more interfaces for communication (such as, for example, packet-based communication) between computer system 1200 and one or more other computer systems 1200 or one or more networks. As an example and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1210 for it. As an example and not by way of limitation, computer system 1200 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network, a Long-Term Evolution (LTE) network, or a 5G network), or other suitable wireless network or a combination of two or more of these. Computer system 1200 may include any suitable communication interface 1210 for any of these networks, where appropriate. Communication interface 1210 may include one or more communication interfaces 1210, where appropriate. Although this disclosure describes and illustrates a particular communication interface, this disclosure contemplates any suitable communication interface.

In particular embodiments, bus 1212 includes hardware, software, or both coupling components of computer system 1200 to each other. As an example and not by way of limitation, bus 1212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1212 may include one or more buses 1212, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A computer-implemented method, comprising:
detecting, by a network controller, a stream of network packets for a computing device;
based on the stream of network packets, detecting available frequency channels of a plurality of network stations by the network controller;
selecting a plurality of available frequency channels of the plurality of network stations to transmit the stream of network packets by the network controller; and
performing, by the network controller based on a network capability of the computing device, one or more of: duplicating data of the stream of network packets over the plurality of available frequency channels, beam re-assignment over one or more network stations of the plurality of network stations and beam duplication over the plurality of network stations.

2. The computer-implemented method of claim 1, further comprising selecting the plurality of available frequency channels based on detecting interference affecting the available frequency channels and performing one or more of: frequency hopping over the plurality of available frequency channels and reassigning frequency among the plurality of available frequency channels, wherein the interference corresponds to interruption in communicating the stream of network packets by one or more of jammers and other sources of interference.

3. The computer-implemented method of claim 2, further comprising:
determining frequency patterns and periodicity of data hopping based on the detected interference; and
performing the frequency hopping over the plurality of available frequency channels based on the frequency patterns and the periodicity of the data hopping.

4. The computer-implemented method of claim 1, further comprising duplicating data on one or more of multiple carriers of the plurality of available frequency channels of the plurality of network stations, and resource blocks (RBs) of the plurality of network stations.

5. The computer-implemented method of claim 1, further comprising:
communicating the stream of network packets by the one or more network stations to the computing device based on any of the one or more of the beam duplication and beam re-assignment.

6. The computer-implemented method of claim 1, wherein each of the data duplication, frequency hopping, and frequency re-assignment is performed in a centralized unit (CU) of the network station, distributed unit (DU) of the network station and radio unit (RU) of a physical layer of the network station.

7. The computer-implemented method of claim 1, further comprising:
determining, by the network controller, whether the plurality of available frequency channels are not affected by an interference;
selecting, by the computing device, network packets from different frequency channels based on determining that the plurality of available channels are not affected by the interference; and
receiving, by the computing device, the network packets from different frequency channels based on one or more of a highest signal to noise ratio (SNR) and a least error vector magnitude (EVM) of the network packets.

8. The computer-implemented method of claim 7, further comprising:
combining the network packets in a frequency band from the different frequency channels based on the network capability of the computing device.

9. A system, comprising:
a network controller configured to:
detect a stream of network packets for a computing device;
based on the stream of network packets, detect available frequency channels of a plurality of network stations by the network controller;
select a plurality of available frequency channels of the plurality of network stations to transmit the stream of network packets by the network controller; and
perform, based on a network capability of the computing device, one or more of: duplicating data of the stream of network packets over the plurality of available frequency channels, beam re-assignment over one or more network stations of the plurality of network stations and beam duplication over the plurality of network stations, wherein a computing device configured to receive the network packets from the network controller based on network capacity of the computing device.

10. The system of claim 9, wherein the network controller is further configured to select the plurality of available frequency channels based on detecting interference affecting the available frequency channels and perform one or more of: frequency hopping over the plurality of available frequency channels and reassigning frequency among the plurality of available frequency channels, wherein the interference corresponds to interruption in communicating the stream of network packets by one or more of jammers and other sources of interference.

11. The system of claim 10, wherein the network controller is further configured to:
determine frequency patterns and periodicity of data hopping based on the detected interference; and
perform the frequency hopping over the plurality of available frequency channels based on the frequency patterns and the periodicity of the data hopping.

12. The system of claim 9, wherein the network controller is further configured to duplicate data on one or more of multiple carriers of the plurality of available frequency channels of the plurality of network stations, and resource blocks (RBs) of the plurality of network stations.

13. The system of claim 9, wherein the network controller is further configured to:
communicate the stream of network packets by the one or more network stations to the computing device based on any of the one or more of the beam duplication and beam re-assignment.

14. The system of claim 9, wherein each of the data duplication, frequency hopping, and frequency re-assignment is performed in a centralized unit (CU) of the network station, distributed unit (DU) of the network station and radio unit (RU) of a physical layer of the network station.

15. The system of claim 9, wherein the system is further configured to:
determine, by the network controller, whether the plurality of available frequency channels are not affected by an interference;
select, by the computing device, network packets from different frequency channels based on determining that the plurality of available channels are not affected by the interference; and
receive, by the computing device, the network packets from different frequency channels based on one or more of a highest signal to noise ratio (SNR) and a least error vector magnitude (EVM) of the network packets.

16. The system of claim 15, wherein the computing device is further configured to:
combine the network packets in a frequency band from the different frequency channels based on the network capability of the computing device.

17. A non-transitory computer-readable medium storing instructions that, when executed by a processor, causes the processor to:
detect, by a network controller, a stream of network packets for a computing device;
based on the stream of network packets, detect available frequency channels of a plurality of network stations by the network controller;
select a plurality of available frequency channels of the plurality of network stations to transmit the stream of network packets by the network controller; and
perform, by the network controller based on a network capability of the computing device, one or more of: duplicating data of the stream of network packets over the plurality of available frequency channels, beam re-assignment over one or more network stations of the plurality of network stations and beam duplication over the plurality of network stations.

18. The non-transitory computer-readable medium of claim 17, wherein the instructions when executed by the processor, further cause the processor to: select the plurality of available frequency channels based on detecting interference affecting the available frequency channels and perform one or more of: frequency hopping over the plurality of available frequency channels and reassigning frequency among the plurality of available frequency channels, wherein the interference corresponds to interruption in communicating the stream of network packets by one or more of jammers and other sources of interference.

19. The non-transitory computer-readable medium of claim 18, wherein the instructions when executed by the processor, further cause the processor to:
determine frequency patterns and periodicity of data hopping based on the detected interference; and
perform the frequency hopping over the plurality of available frequency channels based on the frequency patterns and the periodicity of the data hopping.

20. The non-transitory computer-readable medium of claim 17, wherein the instructions when executed by the processor, further cause the processor to:
communicate the stream of network packets by the one or more network stations to the computing device based on any of the one or more of the beam duplication and beam re-assignment.
